(19) United States
(12) Patent Application Publication
(10) Pub. No.: US 2020/0275176 A1
(43) Pub. Date: Aug. 27, 2020

(54) JEDII - Automated Boom Mic Stand

(71) Applicant: James E Dodge II, Bradenton, FL (US)

(72) Inventor: James E Dodge II, Bradenton, FL (US)

(21) Appl. No.: 16/285,232

(22) Filed: Feb. 26, 2019

(51) Int. Cl. H04R 1/08; H04R 3/00

(52) U.S. Cl. CPC H04R 1/08; H04R 3/00

(57) ABSTRACT

The present invention discloses an automated boom mic stand which allows the movement to full range of motion up and down in height, boom articulation up and down, and boom in and out. Therefore, a complete horizontal and vertical motion is achieved by utilizing the dedicated control on stand base, remote control and/or app remote control integrate mic stand with digital sound boards.

### DESCRIPTION OF THE RELATED ART

Use of mic during the shows or events is an integral requirement. The adjustment of mic as per user height and posture needs to be set up individually. Therefore, there is always a necessity of one dedicated person on the stage to set the mic as per individual's requirement.

There are multiple inventions that have been enlisted in prior art working on the enhancement of mic functionality. A Mic stand having a Korean grant 2,004,232,93Y1 is issued to Korean inventor. The patent discloses a design which is related to a standing room microphone stand is height adjustable arbitrarily adjusted.

In schools, kindergartens, various competitions are to install a microphone and standing room goes. The key is variety of students and speakers or participants in, so to give the height of the mic stand to the height for each individual moderator or facilitator adjusted. If this regulation is currently giving tighten or loosen the fastening nut in the middle of the stand axis to adjust the height manually.

A Stand assembly having anti-rotation feature bearing U.S. Pat. No. 6,612,534B2 is issued to James R. Hennessey. The invention discloses a microphone stand assembly includes an automatically operated anti-rotation arrangement for preventing inadvertent disengagement of the shaft from the base.

A U.S. Pat. No. 9,686,601B1 is a Combination microphone and stand which is issued to Yingzhi Jia. The patent discloses an audio device that sound enhances, that physically supports the sound enhancing, and that has a capability to physically support a video recorder. The audio device includes a microphone head and a stand. The microphone head enhances sound. The stand physically supports the microphone head and has the capability to physically support the video recorder.

A Microphone stand for placement of multiple microphones bearing Danish patent DE 2,020,161,051,16U1 is issued to Thomann GmbH. The patent discloses a Microphone stand (1) for arranging a plurality of microphones, which microphone stand (1) has a foot part (2), which is arranged on the foot part (2) upright arm (3) and a support arm (4), wherein the microphone stand (1) further includes a clamping device (5) for connecting the support arm (4) and the Stan intestine (3), which clamping device (5) comprises a receiving piece (11) for the support arm (4), said receiving piece (11) comprises a resilient ring member (12), that of a movable closure member (13) is enclosed such that the diameter of the elastic ring portion (12) due to the movement relative to the receiving piece (11) of the closure part (13) is reduced to the support arm (4) (on the receiving piece 11 to lock).

A MIC covering detection in personal audio devices bearing U.S. Pat. No. 8,958,571B2 is issued to Cirrus Logic Inc. The patent dioceses a personal audio device, such as a wireless telephone, includes noise canceling circuit that adaptively generates an anti-noise signal from a reference microphone signal and injects the anti-noise signal into the speaker or other transducer output to cause cancellation of ambient audio sounds. An error microphone may also be provided proximate the speaker to estimate an electro acoustical path from the noise canceling circuit through the transducer. A processing circuit uses the reference and/or error microphone, optionally along with a microphone provided for capturing near-end speech, to determine whether one of the reference or error microphones is obstructed by comparing their received signal content and takes action to avoid generation of erroneous anti-noise.

It has to be noted that the current invention proposes an advancement in providing an assembly which is fully automated Boom Mic Stand that can be controlled by a dedicated control on stand base, remote control and/or app remote control. It has full articulating height adjustment 3′ to 6′. The boom arm moves up and down and in and out by remote.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of mic control assembly to adjust as per user's requirement.

It is another objective of the invention to provide a straight mic stands that move up and down in a vertical motion for height.

It is further the objective of the invention to provide a boom and has full range of motion up and down in height, boom articulation up and down, and boom in and out.

It is also the objective of the invention to provide full horizontal and vertical motion.

It is another objective of the invention to provide an automated Boom Mic Stand that can be controlled by a dedicated control on stand base, remote control and/or app remote control.

A further object is to provide an assembly that is simple and easy to use.

A still further object is to provide an assembly that is economical in cost to manufacture.

It is a further object of the present invention to provide a new and mic assembly which is of a durable and reliable construction.

Still yet another object of the present invention is to provide a new and improved automated mic assembly which provides in the apparatuses and methods of the prior art some of the advantages thereof, while simultaneously overcoming some of the disadvantages normally associated therewith.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

One aspect of the present application is directed to provide an automated Boom Mic Stand that can be controlled by a dedicated control on stand base, remote control and/or app remote control.

As per preferred embodiment of the invention an automated Boom Mic Stand is disclosed. The assembly has a boom and full range of motion up and down in height, boom articulation up and down, and boom in and out facility. Therefore, a user can achieve full horizontal and vertical motion.

The assembly is a product which is an automated Boom Mic Stand that can be controlled by a dedicated control on stand base, remote control and/or app remote control. It has full articulating height adjustment 3′ to 6′. The boom arm moves up and down and in and out by remote. The user can achieve the adjustment of mic by using the remote without an external support.

This assembly not only saves a cost of a person who is constantly standing to perform the adjustments of mic but also saves the time consumed in carrying out the same activity.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 100 is a side perspective view of the microphone stand fully extended.

FIG. 200 is a side perspective view of the remote.

FIG. 300 is a top side view of the device of the microphone stand with the base retracted.

FIG. 400 is a top side perspective view of the microphone stand fully extended.

FIG. 500 is a front view of the remote.

FIG. 600 is a side perspective view of the microphone stand with the base and the arm retracted.

FIG. 700 is a top side perspective view of the microphone stand with the base and the arm retracted.

FIG. 800 is a side view of the device of the microphone stand with the base retracted.

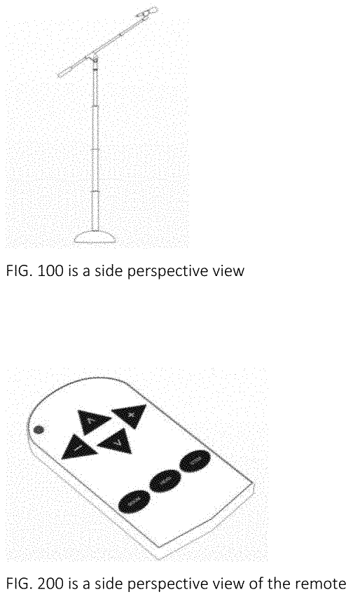

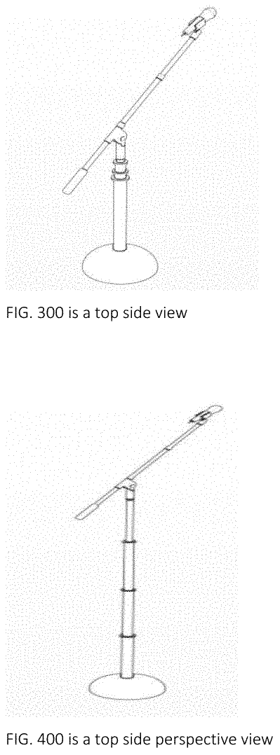

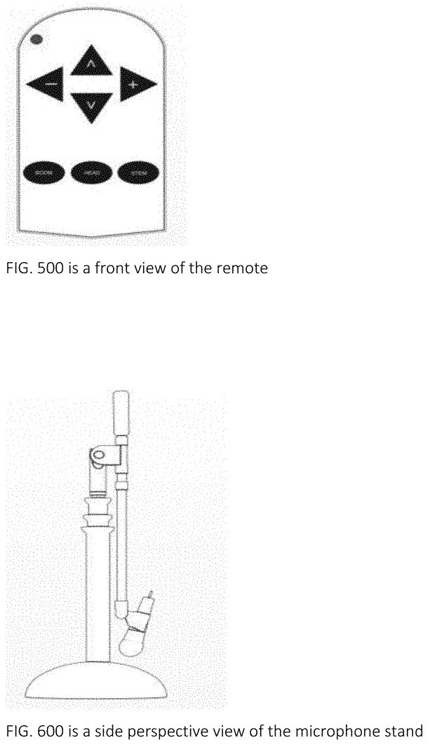

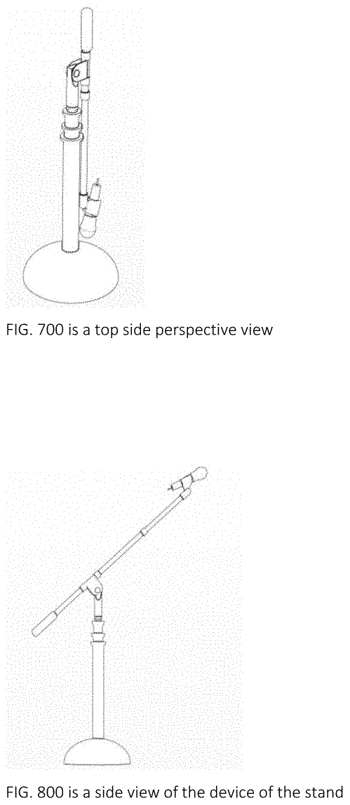

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

I: An automated mic assembly with a boom that has full range of motion up and down in height, boom articulation up and down, and boom in and out, thus allowing complete horizontal and vertical motion.

II: A fully automated remote boom mic stand where: the assembly resembles to traditional mic structure; the assembly allows complete articulating height adjustment 3′ to 6′; the assembly has an automated Boom Mic Stand that can be controlled by a dedicated control on stand base, remote control and/or app remote control.
The uniqueness of our Invention is that one remote or one app controls multiple mic stands separately;
connect the mic stands to the app or controller, and select the one to be controlled without having several remotes or apps;
integrate mic stand with digital sound boards.
Another important feature of our invention is that the mic stands have a battery that is rechargeable. Which can either use a plug to power it or use the battery. While the unit is plugged up it is charging the rechargeable battery.
